(19) United States
(12) Patent Application Publication
(10) Pub. No.: US 2017/0215386 A1
(43) Pub. Date: Aug. 3, 2017

(54) Lighted Animal Harness

(71) Applicant: Peter Pianelli, Matawan, NJ (US)

(72) Inventor: Peter Pianelli, Matawan, NJ (US)

(21) Appl. No.: 15/424,543

(22) Filed: Feb. 3, 2017

Related U.S. Application Data
(60) Provisional application No. 62/290,521, filed on Feb. 3, 2016.

(51) Int. Cl. A01K 27/00; F21L 4/00; F21V 23/04

(52) U.S. Cl. CPC A01K 27/006; A01K 27/008; A01K 27/002; F21V 23/0414; F21L 4/00; F21Y 2115/10

(57) ABSTRACT

Disclosed is a device for providing light to and around a companion or service animal. The device allows for the illumination of an area immediately surrounding the animal that is wearing said device. The device includes a harness which allows for the directed illumination of the area immediately surrounding the animal in order to allow both better visibility for the animal and for a handler. The harness is adjustable and positionable upon the animal to allow for optimal illumination at the discretion of the handler.

### PRIORITY

Priority is claimed to previously filed USPTO provisional patent application, No. 62/290,521.

### BACKGROUND

Various systems exist to illuminate the path of companion or service animals. The current systems typically illuminate a small area or function in a limited set of circumstances. Many of these current systems offer limited utility. Additionally, many of the current systems are designed to illuminate the area directly in front of the companion animal rather than the area below the companion animal, by illuminating the area directly in front of the companion animal obstacles or hazards on the surface which the companion animal is traversing cannot be seen.

The more specialized systems allow for the illumination source to be aimed but can be cumbersome to operate and introduce the possibility that the illumination source may be knocked off of the desired aiming vector. Other systems are not rugged enough to withstand varying weather conditions.

The existing systems are lacking one or more features which allow for a companion animal or handler to easily or safely navigate a dark or dimly lit area.

For the foregoing reasons, there is a need for a more versatile illumination system.

### SUMMARY

The present invention is directed to a device for providing illumination to a companion or service animal that satisfies this need. The device includes a harness, a light source, and a battery. The harness is adjustable to fit various sizes of companion or service animals. The harness may allow for adjustment to modify the specific aim of the light source. The light source and the battery may be shielded from moisture to allow the device to be used under more strenuous conditions. Once the harness has been adjusted, the aim of the light source should hold the same approximate relative position.

### DESCRIPTION

A preferred embodiment of the present invention comprises a device for illuminating the path of a companion or service animal, which allows for the adjustment of the aim of a light source. The preferred embodiment of said device includes a harness, which has connectors that may be adjusted. The preferred embodiment of said device further includes a projection type light emitting diode, said light emitting diode includes a lens which focuses light. The preferred embodiment further includes a battery, which allows said light emitting diode to illuminate without being permanently connected to a fixed power source.

An alternative embodiment of the present invention provides a means for powering said device on or off, said means of powering the device on or off may include one or more of the following features: a simple switch, a light sensor, a remote activated switch, or another variety of adjustable electrical contact.

A further alternative embodiment of the present invention wherein said battery is of a rechargeable variety.

In the Summary above and in the sections below, and in the accompanying drawings, reference is made to particular features of the invention. It is so understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of contain only) components A, B, and C, or can contain not only components A, B, and. C but also one or more other components.

Where reference is made herein to a method comprising two or more defined steps, the defined steps can be carried out in any order or simultaneously (except where the context excludes that possibility), and the method can include one or more other steps which are carried out before any of the defined steps (except where the context excludes that possibility).

The term “at least” followed by a number is used herein to denote the start of a range beginning with that number (which may be a range having an upper limit or no upper limit, depending on the variable being defined. For example “at least 1” means 1 or more than 1. The term “at most” followed by a number is used herein to denote the end of a range ending with that number (which may be a range having 1 or 0 as its lower limit, or a range having no lower limit, depending upon the variable then being defined). For example. “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The invention does not require that all of the advantageous features and all the advantages need to be incorporated into every embodiment of the invention.

### DESCRIPTION OF THE DRAWINGS

FIG. 1 shows a perspective view of an embodiment of the invention.

FIG. 2 shows an exploded view of an embodiment of the invention.

FIG. 3 shows a circuit block diagram of an embodiment of the invention.

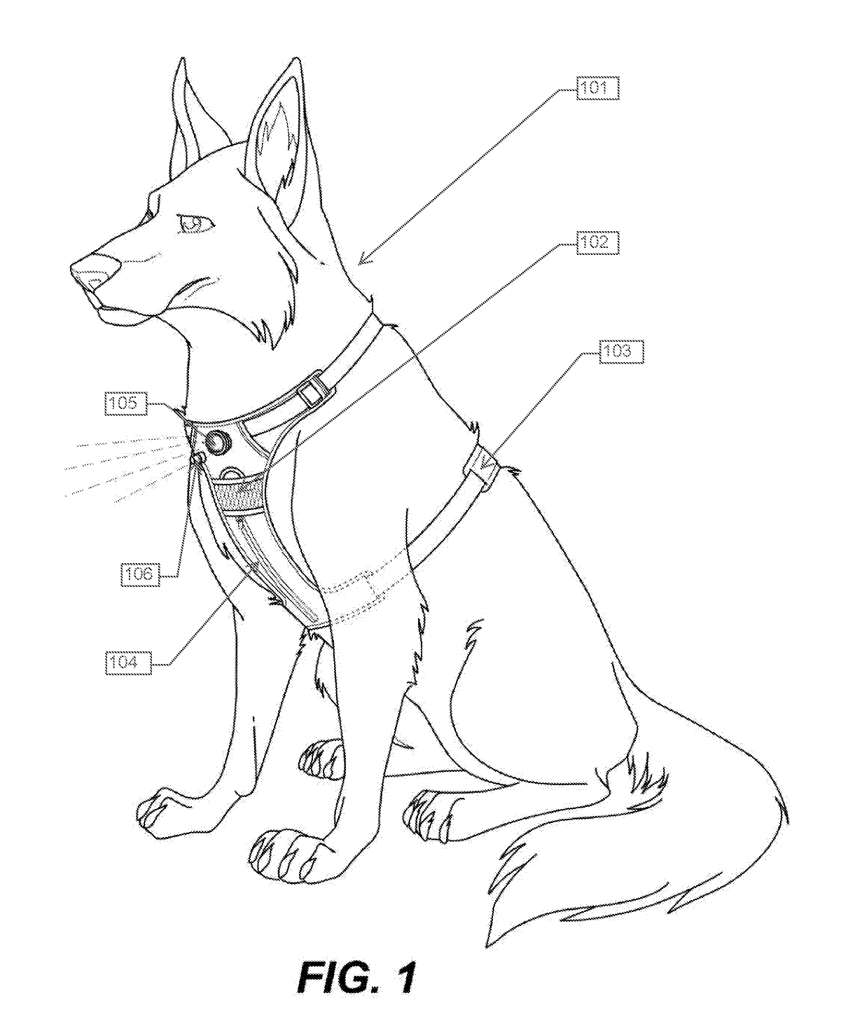

FIG. 1 a perspective view of an embodiment of the invention comprises an example usage of the invention. A companion or service animal 101 it fitted with a harness 102. Said harness 102 includes adjustable straps 103. The adjustable straps 103 are used to connect the harness 102 to the companion or service animal 101. The harness comprises a pocket 104, a light emitting diode 105, and a switch 106. The light emitting diode 105 is connected to the switch 106. The switch is further connected to a battery contained within the pocket 104,

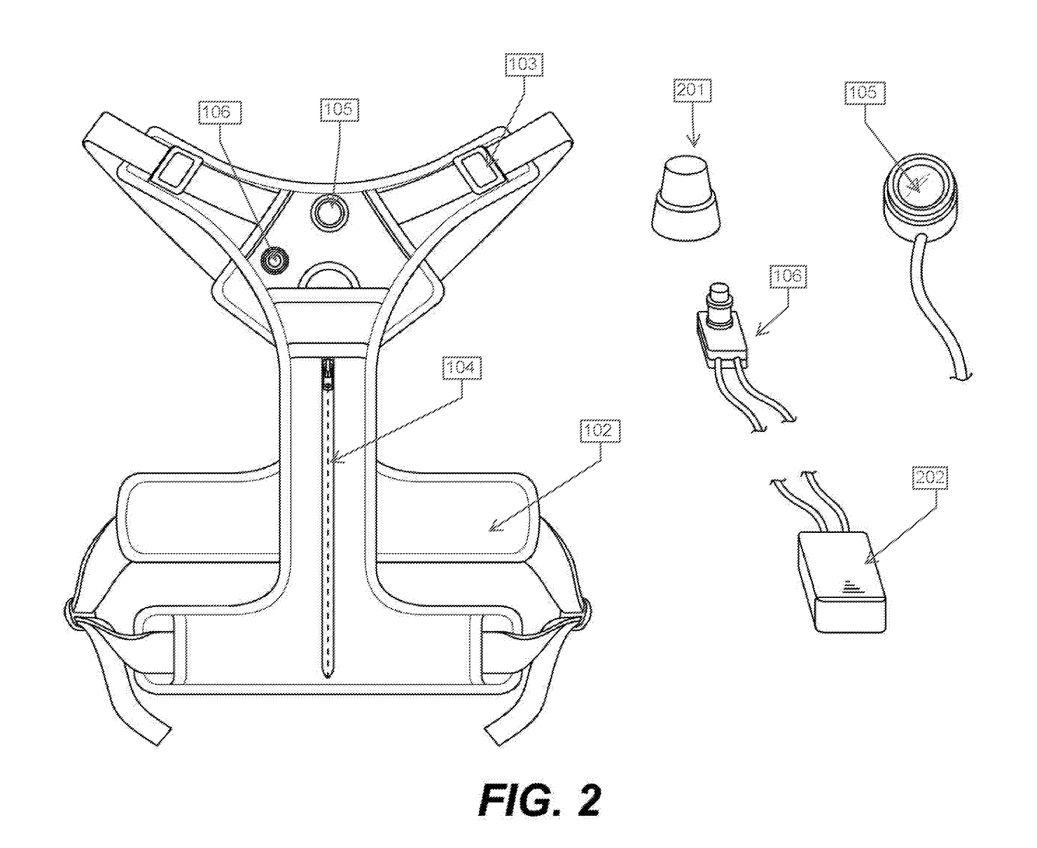

FIG. 2 an exploded view of an embodiment of the invention comprises a harness 102, said harness has adjustable straps 103, a pocket 104, a light emitting diode 105, and a switch 106. The switch 106 is covered by a cover 201. The light emitting diode 105 is connected to the switch 106 and a battery 202. The battery 202 is stored within the pocket 104.

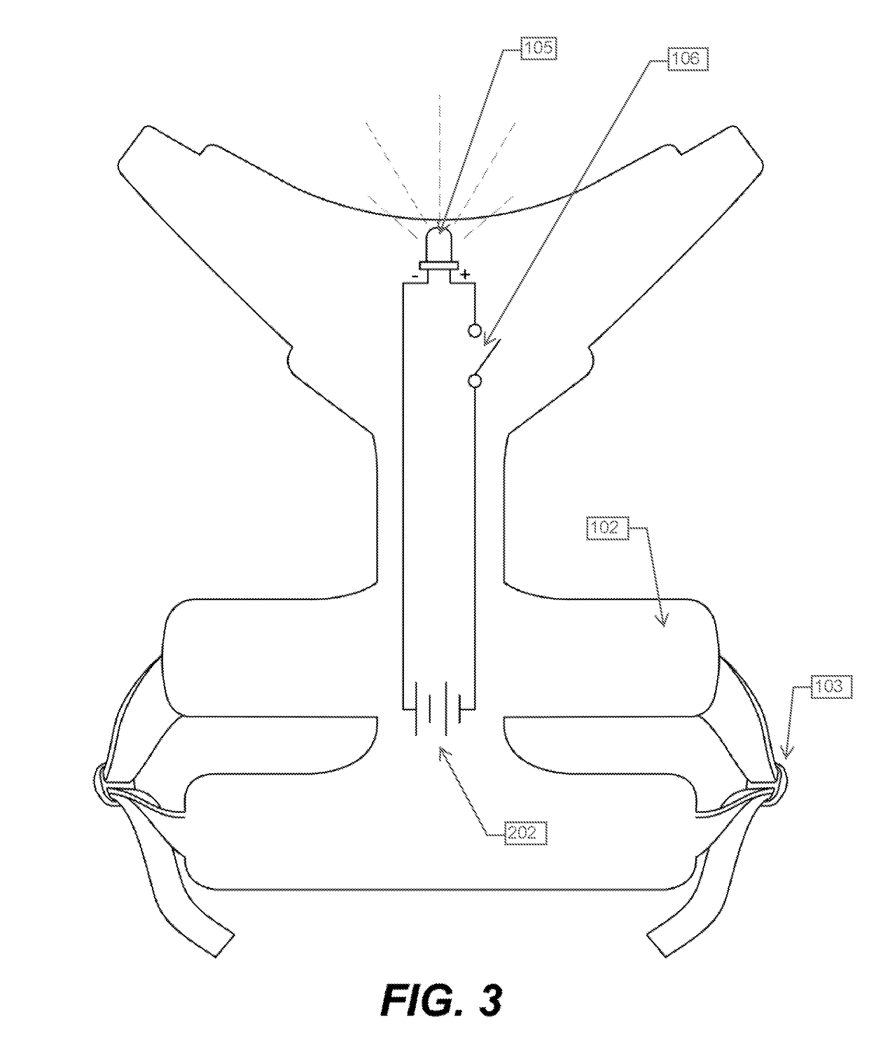

FIG. 3 a circuit block diagram of an embodiment of the invention comprises a light emitting diode 105, said light emitting diode 105 is connected to a switch 106 and further connected to a battery 202. Said light emitting diode 105, said switch 106, and said battery are all connected to a harness 102, which has adjustable straps 103.

Although embodiments of the present invention have been described in considerable detail with reference to certain preferred versions thereof, other versions are possible. For example, the device includes a switch which is tactile in nature, however this switch could be any type of switch including a touch sensitive switch. Therefore, the spirit and scope of this application should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features service the same, equivalent or similar purpose, unless expressly stated otherwise. Thus, unless expressly stated otherwise, each feature disclosed is one example only of a generic series of equivalent or similar features.

What is claimed is:

1. A device illuminating the path of an animal, comprising: a harness, said harness having a ventral, dorsal, front, and back sections, said front section having an adjustable straps, said back section having an adjustable strap, both front and back straps are positionable and sizable along the body of a wearer, said harness further comprising a light emitting diode which is positioned on said front section of said harness, said harness further comprising a pocket located along the ventral section of said harness, said pocket containing a battery, said battery being connected to a switch located along the ventral section of said harness, said switch is further connected to said light emitting diode to allow the flow of current between said battery, said switch, and said light emitting diode.

2. The device of claim 1 where said pocket further comprises a closure which allows for securely storing said battery.

3. The device of claim 1 where said battery is removable and replaceable.

4. The device of claim 2 where said battery is removable and replaceable.

5. The device of claim 1 where said light emitting diode is removable and replaceable.

6. The device of claim 2 where said light emitting diode is removable and replaceable.

7. The device of claim 3 where said light emitting diode is removable and replaceable.

8. The device of claim 4 where said light emitting diode is removable and replaceable.

9. The device of claim 1 further comprises a handle which is attached to the dorsal section of said harness.

10. The device of claim 2 further comprises a handle which is attached to the dorsal section of said harness.

11. The device of claim 3 further comprises a handle which is attached to the dorsal section of said harness.

12. The device of claim 4 further comprises a handle which is attached to the dorsal section of said harness.

13. The device of claim 5 further comprises a handle which is attached to the dorsal section of said harness.

14. The device of claim 6 further comprises a handle which is attached to the dorsal section of said harness.

15. The device of claim 7 further comprises a handle which is attached to the dorsal section of said harness.

16. The device of claim 8 further comprises a handle which is attached to the dorsal section of said harness.
